(19) United States
(12) Patent Application Publication
(10) Pub. No.: US 2020/0171685 A1
(43) Pub. Date: Jun. 4, 2020

(54) SHAVING HEAD AND SHAVER

(71) Applicant: Zhongshan Zuoke Personal Care Co.,ltd., Zhongshan (CN)

(72) Inventors: Ying Liu, Zhongshan (CN); Desong Liu, Zhongshan (CN)

(73) Assignee: Zhongshan Zuoke Personal Care Co.,ltd.

(21) Appl. No.: 16/457,944

(22) Filed: Jun. 29, 2019

(30) Foreign Application Priority Data
Nov. 29, 2018 (CN) 201811445230.3

(51) Int. Cl. B26B 21/22; B26B 21/40

(52) U.S. Cl. CPC B26B 21/222; B26B 21/4012; B26B 21/4075

(57) ABSTRACT

The present disclosure provides a shaving head, including a blade and a blade holder. The holder includes a base for connecting the shaver handle, and a cover contacting the human skin during shaving, the base and the cover is detachably connected and the blade is fixed to the base. The present disclosure also provides a shaver. The present disclosure can replace only the cover.

### TECHNICAL FIELD

The present disclosure relates to the technical field of the shaver, and more particularly to a shaving head and shaver.

### BACKGROUND

A shaver is a device for shaving a beard. The shaver generally includes a shaving head having a blade fixed therein, and the shaver blade scrapes the beard while contacting the human skin. When the shaving head is used in the long-term, the surface in contact with human skin is easily contaminated. In order to avoid skin infection, the entire shaving head (including the blade) needs to be replaced from the shaver, resulting in waste of resources and increased cost.

### SUMMARY OF THE DISCLOSURE

In view of this, it is necessary to provide a shaving head and shaver, which can be replaced only by the cover.

A shaving head provided by the present disclosure including a blade and a holder, the holder includes a base for connecting the shaver handle and a cover for contacting the human skin during shaving, the base is detachtably connected to the cover, the blade is fixed on the base.

Further, the cover is provided with a plurality of first holding portions, and the base is provided with second holding portions corresponding the first holding portions; the first holding portion is engaged with the corresponding second holding portion.

Further, a panel is a frame structure, and an intermediate opening of the frame structure is configured for exposing a scraping surface of a blade.

Further, the frame structure includes a first connecting wall, a second connecting wall, and a side wall connecting the first connecting wall and the second connecting wall; the first connecting wall and the second connecting wall are substantially parallel to the blade; and a soft body is fixed on an outer surface of the first connecting wall and/or the second connecting wall and/or the side wall, respectively.

Further, a slot is provided on the base, the blade includes a latching portion fixed by the slot and a shaving portion provided with a knife connected to the latching portion; and two ends of the blade are respectively fixed on the base by being surrounded by a fixing strip.

Further, an angle between the shaving portion and the latching portion is a blunt angle, and a block with a spacer is formed on the base; the slot is formed before the two adjacent blocks, and the front end surface of the block is provided with a slope supporting the shaving portion.

Further, the block is located at an end position of the blade, and the fixing strip presses the shaving portion around the block.

Further, the fixing strip includes a depression bar, and both ends of the depression bar are bent to extend toward a pressing direction to form a side portion, the side portion is extended toward an inner side of the depression bar to form a bottom portion, the bottom portion is extended toward the depression bar to form a hook portion, the side portion, the bottom portion and the hook portion cooperating with the base to press the blade against the base.

Further, a middle portion of the base is provided with a holding member, and a front end of the holding member is provided with the slot, and the rear end of the holding member is formed with a curved surface for guiding the shaver handle.

A shaver is further provided by the present disclosure, including a shaver handle, further comprising the shaving head; a base of the shaving head is connected to the shaver handle.

Compared with the prior art, the advantages of present disclosure are as following: the cover is fixedly connected with the base mounted with the blade in a detachable manner, and the cover is easily contaminated due to long-term contact with human skin, and the cover can be replaced after a period of use, is not required to replace the entire shaving head with the blade, so that resources and costs are saved.

### BRIEF DESCRIPTION OF THE DRAWINGS

FIG. 1 is a schematic perspective view of the present disclosure.

FIG. 2 is a schematic perspective view of the opposite direction of FIG. 1.

FIG. 3 is a cross-sectional view taken along line A-A of FIG. 1;

FIG. 4 is a cross-sectional view taken along line B-B of FIG. 1;

The present disclosure will be further illustrated by the following detailed description in conjunction with the accompanying drawings.

### DETAILED DESCRIPTION OF THE EMBODIMENTS

The technical solutions in the embodiments of the present disclosure will be clearly and completely described in the following with reference to the accompanying drawings in the embodiments of the present disclosure. It is obvious that the described embodiments are only a part of the embodiments of the present disclosure, but not all embodiments. All other embodiments obtained by those skilled in the art based on the embodiments of the present disclosure without creative efforts are within the scope of the present disclosure. It should be understood that the connection relationships shown in the drawings are for convenience of clarity and do not limit the connection manners. In order to teach the principles of the present disclosure, some conventional aspects have been simplified or omitted, and those skilled in the art will understood that modifications derived from these embodiments fall within the scope of the present disclosure.

It should be noted that when a component is considered to be “connected” to another component, it can be directly or indirectly connected to another component at the same time. All technical and scientific terms used herein have the same meaning as commonly understood by one of ordinary skill in the art to which this present disclosure belongs, unless otherwise defined. It should also be noted that the terms “installation”, “connected”, and “connected” are to be understood broadly, and may be, for example, it can be a fixed connection, a detachable connection, or an integral connection; it can be a mechanical connection or an electrical connection, or can be the internal communication of the two components. The specific meaning of the above terms in the present disclosure can be understood in a specific case by those skilled in the art. The terminology used in the description of the present disclosure is for the purpose of describing particular embodiments and is not intended to limit the present disclosure.

It should also be noted that, in the description of the present disclosure, the terms “center”, “upper”, “lower”, “left”, “right”, “vertical”, “horizontal”, “inside”, “outside” and the like are indicated the orientation or positional relationship based on the orientation or positional relationship shown in the drawings, and is merely for the convenience of describing the present disclosure and simplifying the description, and does not indicate or imply that the device or component referred to has a specific orientation, constructed or operated in a particular orientation, therefore it is not to be construed as limiting the present disclosure. Moreover, the terms “first,” “second,” and “third” are used for descriptive purposes only and are not to be construed as indicating or implying relative importance.

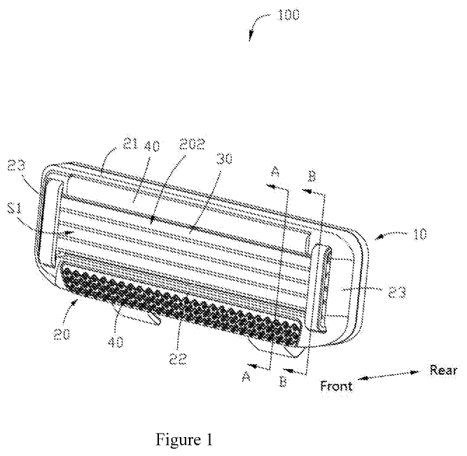

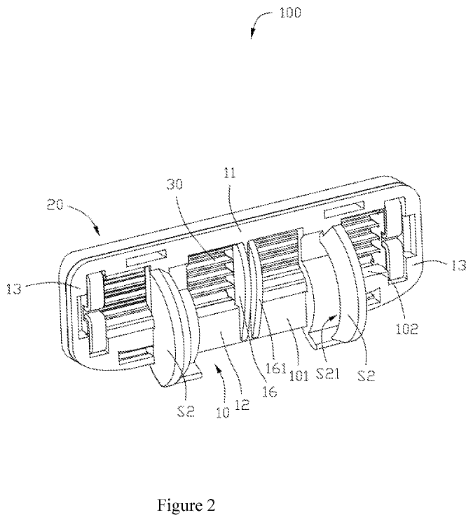

Please refer to FIG. 1 and FIG. 2, FIG. 1 is a schematic perspective view of the present disclosure, and FIG. 2 is a schematic perspective view of the opposite direction of FIG. 1. The present disclosure provides a shaving head 100 that can be fixed to a shaver handle (not shown), such as directly or detachably or rotationally fixed. The shaver handle can be used with an existing shaver handle.

The shaving head 100 has a front end and a rear end, wherein the front end has a shaving surface S1, the rear end has a connecting structure S2 connecting the shaver handle, and the connecting structure S2 can be a connecting body with an arcuate groove S21. The shaft or other structure of the shaver handle can be coupled to the groove to realize rotationally securing the shaving head 100 to the shaver handle.

The shaving head 100 includes a base 10 and a cover 20. The base 10 and the cover 20 is detachably connected to separate the cover 20 from the shaving head 100. The base 10 includes a front frame 101 and a connection structure S2 connected to a rear end of the front frame 101. The front frame 101 includes a top wall 11, a bottom wall 12, and two side walls 13 connecting the top wall 11 and the bottom wall 12. In the present embodiment, the front frame 101 is similar to a square frame. The side of front frame 101 facing to the front end and adjacent to the frame opening position is formed with an annular protrusion 102 protruding toward the front, so as to be matched with the subsequent cover 20, and the annular protrusion 102 can be formed with a slot (not shown) for matching the pins (not shown) of the subsequent cover 20. One or more blades 30 are disposed in the frame opening of the front frame 101, and the blades 30 are substantially parallel to the top wall 11 and the bottom wall 12, and the scraping surface of the blade 30 is adjacent to the front end.

A groove 201 matching the annular projection 102 is formed on the cover surface 20, and a pin is formed in the groove 201. When installed, the cover 20 is fastened to the base 10, and the annular projection 102 is received in the groove 201, and the pin is inserted into the groove. In this embodiment, the cover 20 may also be in the shape of a frame. Specifically, the cover 20 includes a first connecting wall 21, a second connecting wall 22, and a side wall 23 being connected with the first connecting wall 21 and the second connecting wall. The first connecting wall 21 and the second connecting wall 22 are substantially parallel to the blade 30. The intermediate opening 202 of the cover 20 is used to expose the scraping surface of the blade 30, so that the scraping surface of the blade 30 is easy to be in contact with human skin, thereby scraping the beard. When the beard is scraped off by the blade 30, the front end surface of the cover 20 comes into contact with the skin of the human body. In order to improve the comfort of the cover 20 when it comes into contact with the human body and to provide a certain frictional force, a soft body 40, such as a silica gel or the like, which is in contact with the human skin can be fixed on the cover 20. In the present embodiment, the soft body 40 is disposed at the front end of the first connecting wall 21 and the second connecting wall 22 having a large area in contact with human skin.

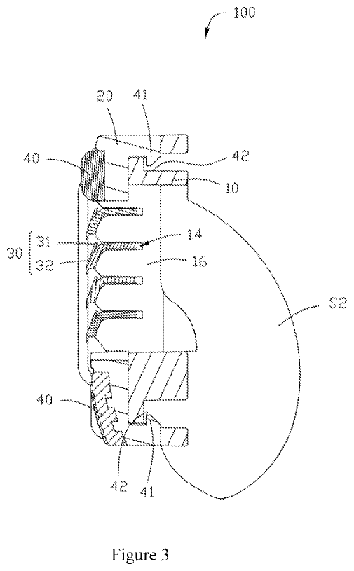

In the present embodiment, referring to FIG. 3, a first holding portion 41 may be disposed on the front frame 101, and a second holding portion 42 may be disposed on the cover 20. The first holding portion 41 and the second holding portion 42 are fastened together, so that the base 10 and the cover 20 are detachably connected to form an integral body. Preferably, the first holding portion 41 is a slot, and the second holding portion 42 is a hook or vice versa.

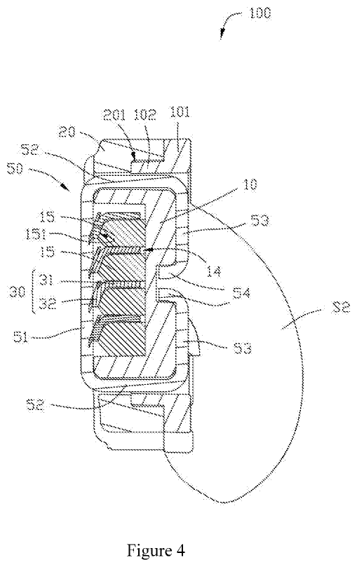

Referring to FIG. 4, there is a slot 14 on the base 10, which can be located at the positions of two side walls 13 of the base 10 or at the middle position of the base 10. Specifically, the slot 14 can be formed between two adjacent blocks 15 are formed between the two side walls 13, and the slot 14 is formed between two adjacent blocks 15. Or, referring to FIGS. 2 and 3, the holding member 16 can be formed in the middle of the base 10, and the slot 14 can be formed on the holding member 16. In order to facilitate the rotation of the base 10 to connect the handle, the rotation direction of the base 10 is formed at the front end of the holding member 15, while a curved surface 161 is formed at the rear end of the holding member 16. When the shaving head 100 rotates with the shaver handle, the curved surface 161 acts as the guide rail.

The blade 30 includes a latching portion 31 fixed by the slot 14 and a shaving portion 32 having a blade attached to the latching portion 31, wherein the latching portion 31 and the shaving portion 32 may be on the same plane, that is, the angle between the two is 180 degrees, or the latching portion 31 and the shaving portion 32 may be at an angle, for example, an obtuse angle. When installation, the latching portion 31 is received in the slot 14. A support surface 151 may be provided on the front end surface of the block 15, and the support surface 151 is preferably a slope to support the shaving portion 32 which is formed an obtuse angle with the latching portion 31, so that the blade 30 can be well fixed on multiple sides, and the blade 30 is not easily bent by external force which affects the shaving effect.

In order to further improve the stability of the blade 30 mounted on the base 10 and avoid user injury, the fixing strip 50 may be wrapped around the outer circumference of the blade 30, and the fixing strip 50 may be pressed against the base 10. The fixing strip 50 may be selected a bendable metal strip, or can be made of plastic or other materials. In the present embodiment, the fixing strip 50 is located at the end position of the blade 30 and corresponds to the position of the block 15. When the fixing strip 50 fixedly wraps the blade 30 around the base 10, the end of blade 30 is pressed against the block 15 by the fixing strip 50.

Further, the fixing strip 20 includes a depression bar 51, and both ends of the depression bar 51 are bent to extend toward a pressing direction to form a side portion 52. The side portion 52 is extended toward an inner side of the depression bar 51 to form a bottom portion 53, the bottom portion 53 is extended toward the depression bar 51 to form a hook portion 54. The side portion 52, the bottom portion 53 and the hook portion 54 cooperate with the base 10 to press the blade 30 against the base 10. When the blade 30 or the depression bar 51 is applied by an external force, the side portion 52, the bottom portion 53, and the hook portion 54 form a hook body, which is tightly hooked on the base 10, and the depression bar 51 is hardly deformed, so that the firmness of the blade 30 can be always ensured.

In the specification and claims of the present application, the words “including/comprising” and the words “comprise/include” and the modification thereof are used to indicate the existence of the described features, values, steps or components, but not excluding the existence or addition of one or more other features, values, steps, components, or combinations thereof.

Some features of the present disclosure are described in the various embodiments for clarity of the description, however, these features may also be described in connection with a single embodiment. Rather, some of the features of the present disclosure are described in a single embodiment for the sake of brevity, however, these features may also be described individually or in any suitable combination in different embodiments.

The above is only the preferred embodiment of the present disclosure, and is not intended to limit the present disclosure. Any modifications, equivalent substitutions and improvements made within the spirit and principles of the present disclosure should be included in the scope of the present disclosure.

What is claimed is:

1. A shaving head comprising a blade and a holder, wherein the holder comprises a base for connecting the shaver handle and a cover for contacting the human skin during shaving, the base is detachtably connected to the cover, the blade is fixed on the base.

2. The shaving head according to claim 1, wherein the cover is provided with a plurality of first holding portions, and the base is provided with second holding portions corresponding the first holding portions; the first holding portion is engaged with the corresponding second holding portion.

3. The shaving head according to claim 1, wherein a panel is a frame structure, and an intermediate opening of the frame structure is configured for exposing a scraping surface of a blade.

4. The shaving head according to claim 3, wherein the frame structure comprises a first connecting wall, a second connecting wall, and a side wall connecting the first connecting wall and the second connecting wall; the first connecting wall and the second connecting wall are substantially parallel to the blade; and a soft body is fixed on an outer surface of the first connecting wall and/or the second connecting wall and/or the side wall, respectively.

5. The shaving head according to claim 1, wherein a slot is provided on the base, the blade comprises a latching portion fixed by the slot and a shaving portion provided with a knife connected to the latching portion; and two ends of the blade are respectively fixed on the base by being surrounded by a fixing strip.

6. The shaving head according to claim 5, wherein an angle between the shaving portion and the latching portion is an obtuse angle, and a block with a spacer is formed on the base; the slot is formed before the two adjacent blocks, and the front end surface of the block is provided with a slope supporting the shaving portion.

7. The shaving head according to claim 6, wherein the block is located at an end position of the blade, and the fixing strip presses the shaving portion around the block.

8. The shaving head according to claim 5, wherein, the fixing strip comprises a depression bar, and both ends of the depression bar are bent to extend toward a pressing direction to form a side portion, the side portion is extended toward an inner side of the depression bar to form a bottom portion, the bottom portion is extended toward the depression bar to form a hook portion, the side portion, the bottom portion and the hook portion cooperating with the base to press the blade against the base.

9. The shaving head according to claim 5, wherein, a middle portion of the base is provided with a holding member, and a front end of the holding member is provided with the slot, and the rear end of the holding member is formed with a curved surface for guiding the shaver handle.

10. A shaver, comprising a shaver handle, wherein, further comprising a shaving head according to claim 1, a base of the shaving head is connected to the shaver handle.
